(19) United States
(12) Patent Application Publication
(10) Pub. No.: US 2004/0025700 A1
(43) Pub. Date: Feb. 12, 2004

(54) Jelly fruit drink

(76) Inventor: Gerry Dunn, Road Coathbridge Lanarkshire (GB)

Correspondence Address: Fleshner & Kim, PO Box 221200, Chantilly, VA, 22151-1200, US

(21) Appl. No.: 10/415,471

(22) PCT Filed: Oct. 30, 2001
(86) PCT No.: PCT/GB01/04812

(30) Foreign Application Priority Data
Oct. 31, 2000 (GB) 0026550.4

(51) Int. Cl. A23L 1/00

(52) U.S. Cl. 99/275

(57) ABSTRACT

A non-newtonian, thixotropic jelly drink (1) comprising fruti juice, sweeteners, acidity regulators and preservatives and gelling agents has a pH in the range of pH 2.5 to pH 4.5 and can be stored in good condition for a reasonable length of time. The jelly drink is typically provided in a flexible container (2). A method is also described of producing a jelly drink.

This invention relates to consumable gels, their method of manufacture and the method of packaging said gels. In particular, this invention relates to jelly fruit drinks.

Consumable jellies are available in many flavours shapes and forms. These jellies often have fruity flavours and bright colours and are particularly appealing to children. However, the majority of consumable jellies do not come in a “ready to eat” form. Many consumable jellies are concentrated gels to which hot water must be added to melt the concentrate and then the mix allowed to cool and re-set, while other jellies take the form of gelatine power which again requires the addition of water and time to set.

In order to provide “ready to eat” jellies, a number of set jelly products can now be found in pots. While not requiring the addition of water or any setting time, the pots are not conducive to easy eating and a utensil is required. Pots of jelly are therefore not a convenient “ready to eat” option. U.S. Pat. No. 5,385,747 entitled “Process for making a fruit gel composition in a squeeze container” describes a consumable gel packaged in a flexible container, where when the container is squeezed the gel is extruded through a discharge opening. The problem with this consumable gel is that in forming the composition, the gel and flavourant systems are separately mixed and this need for two separate systems means that producing the consumable gel is a complicated process. A second problem is that the gel developed by this process is of a firm semi-solid texture which must be squeezed from the container in order for it to be consumed and the squeezing process often results in spillage.

This invention realises that it would be useful to provide a convenient “ready to eat” jelly drink which has a simple method of manufacture and does not require a utensil for consumption. The invention also realises that it would be useful if the jelly drink was of a liquid consistency which allows the jelly drink to be obtained from the packaging using suction.

The first objection of this invention is to provide a simplified method for producing a “ready to eat” consumable jelly drink.

A further object of this invention is to provide a consumable jelly drink which may be easily consumed without the need for a utensil.

Another object of this invention is to provide a method of manufacturing a consumable jelly drink which fulfils the previous objectives.

A further object of this invention is to provide a method of packaging a consumable jelly drink which fulfils the previous objective.

A yet further object of this invention is to provide a consumable jelly drink which has low manufacturing costs.

According to a first aspect of the present invention there is provided a jelly drink which is a non-newtonian, thixotropic fluid which flows when set, retains viscoelastic properties and comprises xanthan gelling agent and locust bean gum gelling agent (also referred to as carob gum).

Preferably the jelly drink includes flavourings.

Most preferably the jelly drink comprises fruit flavourings.

Preferably the fruit flavourings take the form of fruit juice.

Preferably the jelly drink comprises sugars and/or sweeteners, acidity regulators and preservatives.

Most preferably 5% of the jelly drink comprises fruit juice as well as sweeteners, acidity regulators and preservative.

Preferably the jelly drink may have a pH in the range from pH 2.5 to pH 4.5.

Most preferably the jelly drink has a pH of 3.6.

According to a second aspect of the invention, there is provided a method of manufacturing a jelly drink as described in the first aspect of this invention; wherein the ingredients are dissolved in water and mixed, taken through a heating cycle to activate, pasteurise and de-aerate the gel and then packaged in a flexible container.

Preferably the ingredients are dissolved in 500 litres of water for an 800 litre batch.

Most preferably the xanthan gum and locust bean gum (also known as carob gum) are dry mixed prior to use.

Preferably the ingredients are added in the following order:

Water

Sweeteners and preservative

Food grade acid

Fruit juice and additional flavourings

Locust bean gum and xanthan gum

Water

Acidity regulator

Preferably a mixer is used to mix the ingredients, wherein the mixer is at a speed which dissolves and mixes the product, but does not destroy the gel.

Most preferably the ingredients are mixed for 30 minutes to allow hydration of the gel prior to the addition of an acidity regulator.

Usually once the product has been mixed it undergoes a heating cycle.

Preferably the product is circulated for 10 minutes through the heating cycle to improve the product flow.

Preferably the product is preheated to 40° C.

Preferably after the preheat the product is de-aerated.

Preferably the gel is activated and the product pasteurised in a heating section by heating to a suitable high temperature.

Most preferably the gel is activated and the product pasteurised by heating to 93° C.

Preferably the high temperature is held for a period of time to sterilise and protect the gel complex.

Most preferably the high temperature is held for 10 seconds.

According to a third aspect of this invention, there is provided a method of packaging a jelly drink as in the first aspect of this invention.

Preferably the jelly drink is packaged into a flexible container made of any suitable water impermeable material.

Optionally the flexible container may be made of plastic.

Preferably the flexible container is provided with a preformed opening covered with a suitable cap.

Most preferably the flexible container does not have a pre-formed opening, but is produced from a material which can be easily torn or cut to provide an opening.

Preferably the jelly drink is packaged after the heating cycle when the temperature has cooled slightly.

Most preferably the jelly drink is packaged at a temperature of 76° C.

Preferably the packaged jelly drink is maintained at the packaging temperature for a prolonged period of time to allow for sterilisation of the container.

Most preferably the packaged jelly drink is maintained at the packaging temperature for 2.5 minutes.

In order to provide a better understanding of the invention, embodiments of the invention will now be described by way of example only, and with reference to the following figure, in which:

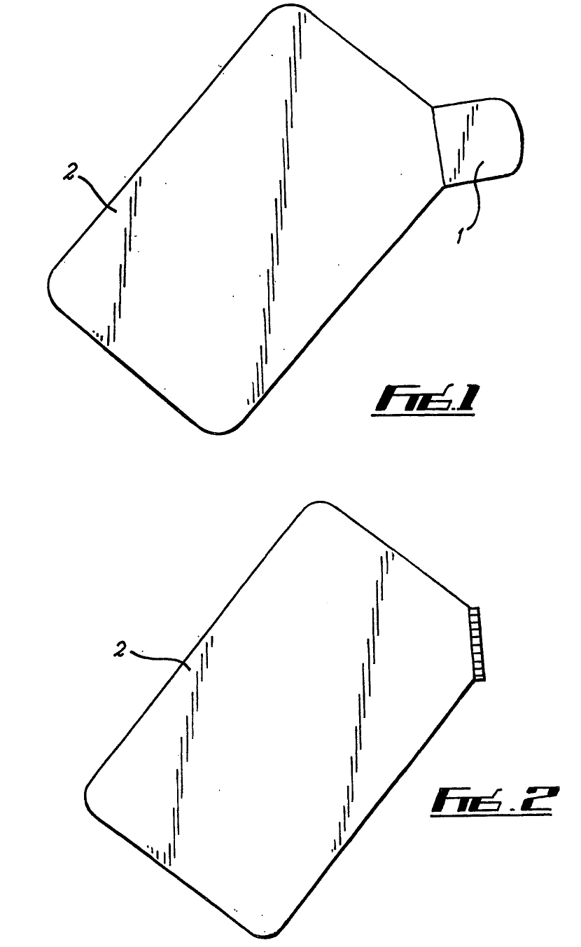

FIG. 1 is a jelly drink according to this invention which is packaged in a flexible container that is open to allow the jelly drink to be squeezed out; and

FIG. 2 is a jelly drink according to this invention, which is packaged in a flexible container that is closed so that they jelly drink cannot be squeezed out.

According to the first aspect of this invention, there is provided a non-newtonian, thixotropic jelly drink 1 comprising 5% fruit juice, sweeteners, acidity regulators and preservative. The jelly drink 1 also comprises gelling agents, xanthan gum and locust bean gum (also known as carob gum). The jelly drink 1 has a pH of 3.6 and is pasteurised to ensure that it can be stored in good condition for a reasonable length of time.

In order to provide an easy way of consuming the jelly drink 1, it is provided in a flexible container 2. The flexible container 2 is provided either with a removable lid or stopper at one end, or with region that can easily form an opening. When pressure is applied to the outside of the flexible container 2, this causes the jelly drink 1 to be pushed through the opening in the flexible container 2. Alternatively the jelly drink 1 may be obtained from the flexible container 2 by applying suction to the opening, as the jelly drink 1 is in the form of a liquid.

The second aspect of this invention is the method of producing a jelly drink 1. Approximately 500 litres of cold water are added to a mixing tank. The sweeteners and preservatives are then added to the mixing tank and allowed to dissolve. Citric acid is then added to the mix until the product is clear and then fruit juice and flavours are added.

The xanthan gum and locust bean gum (or carob gum) is dry mixed in a separate container. In order to ensure the gelling agents are mixed correctly, the container for mixing is dried prior to use. The dry mixed gelling agents are then added to the liquid mix with mixers or via a kelco funnel. The mixer that is used is powerful enough to dissolve and mix the product, but not so powerful that it destroys the gel properties of the mix.

Once the dry mixed gelling agents have been added, the tank is immediately topped up to the final level and the product mixed for 30 minutes to allow hydration of the gel. During the mixing period a trisodium citrate solution is made up. The trisodium citrate solution is then added to the mixed solution and the pH levels of the mixed gel solution are checked and adjusted accordingly so that they are pH 3.6. The product, which is a jelly drink, can then be checked.

Once the jelly drink has been mixed it is then pasteurised so that it is safe for consumption and can be stored in hygienic conditions for a reasonable amount of time. The product is transferred to a balance tank and is allowed to circulate around the heating system for at least 10 minutes prior to the start of production to improve product flow. The product is preheated to at least 40° C.

The product is de-aerated and then fed into the regeneration section of the tank which allows for some energy saving. The product is then heated to a minimum of 91° C. which allows the sterilisation of the gel product without destroying the gel complex. The temperature is held for 10 seconds, which is critical for the sterilisation and protection of the complex. The product is then again passed to the regeneration section.

The third aspect of the invention relates to the method of packaging the jelly drink of the first aspect of the invention which has been produced using the method described in the second aspect. After pasteurisation, the jelly drink product 1 is allowed to cool to approximately 76° C. which is a critical temperature to allow both sterilisation of the container 2 and protection of the product. The jelly drink product 1 is then hot filled into flexible containers 2 and the temperature is maintained for a minimum of 2.5 minutes. The temperature hold time is critical for the sterilisation of the container. The flexible containers are provided in a material that is able to withstand the hot filling and which allows the thixotropic properties of the jelly drink to be utilised.

The jelly drink product 1, packaged in a flexible container 2, can then be cooled in a water bath if required and is then ready for storage or distribution.

It can be seen that there are a number of advantages to this jelly drink, the method of producing it and the method of packaging it. The production and packaging methods provide a consumable jelly drink which can be easily and relatively cheaply produced (as the materials used can cost up to 10 times less than other materials which produce similar characteristics). The pasteurisation means that the product can be stored for a reasonable amount of time. Also, the jelly drink is easy to consume as it is provided in a flexible container which expels the drink when squeezed, so there is no requirement for an eating utensil.

The embodiments disclosed above are merely exemplary of the invention, which may be embodied in different forms. Therefore, the details disclosed herein are not to be interpreted as limiting, but merely as a basis for the claims and for teaching one skilled in the art as to the various uses of the present invention in any appropriate manner.

1. A jelly drink which is non-newtonian, thixotropic fluid which flows when set, retains viscoelastic properties and comprises xanthan gelling agent and locust bean gum gelling agent.

2. A jelly drink as claimed in claim 1, which includes flavourings.

3. A jelly drink as claimed in claim 2, wherein the flavourings are fruit flavourings.

4. A jelly drink as claimed in claims 2 to 3, wherein the fruit flavourings take the form of fruit juice.

5. A jelly drink as claimed in any one of the preceding claims, comprising sugars and/or sweeteners, acidity regulators and preservatives.

6. A jelly drink as claimed in any one of the preceding claims, comprising fruit juice as well as sweeteners, acidity regulators and preservative.

7. A jelly drink as claimed in any one of the preceding claims, having a pH in the range of pH 2.5 to pH 4.5.

8. A jelly drink as claimed in any one of the preceding claims, having a pH of 3.6.

9. A method of manufacturing a jelly drink as claimed in claims 1 to 8, wherein the ingredients are dissolved in water and mixed, taking through a heating cycle to activate, pasteurise and de-aerate the gel and then packaged in a flexible container.

10. A method as claimed in claim 9, wherein the ingredients are dissolved in 500 litres of water for an 800 litre batch.

11. A method as claimed in claims 9 to 10, wherein the xanthan gum and locust bean gum are dry mixed prior to use.

12. A method as claimed in any one of claims 9 to 11, wherein the ingredients are added in the order:
Water
Sweeteners and Preservatives
Food grade acid
Fruit juice and additional flavourings
Locust bean gum and xanthan gum
Water
Acidity regulator

13. A method as claimed in any one of claims 9 to 12, wherein the mixer is used to mix the ingredients.

14. A method as claimed in claim 13, wherein the mixer is at a speed which dissolves and mixes the product, but does not destroy the gel.

15. A method as claimed in any one of the claims 9 to 14, wherein the ingredients are mixed for 30 minutes to allow hydration of the gel prior to the addition of an acidity regulator.

16. A method as claimed in any one of claims 9 to 15, wherein once the product has been mixed it undergoes a heating cycle.

17. A method as claimed in any one of claims 9 to 16, wherein the product is circulated for 10 minutes through the heating cycle to improve the product flow.

18. A method as claimed in any one of claims 9 to 17, wherein the product is preheated to 40° C.

19. A method as claimed in any one of claims 9 to 18, wherein after the product is preheated to 40° C., the product is de-aerated.

20. A method as claimed in any one of claims 9 to 19, wherein the gel is activated and the product pasteurised in a heating section by heating to a suitable high temperature.

21. A method as claimed in any one of claims 9 to 20, wherein the gel is activated and the product pasteurised by heating to 93° C.

22. A method as claimed in any one of the claims 9 to 21, wherein the high temperature is held for a period of time to sterilise and protect the gel complex.

23. A method as claimed in any one of claims 9 to 22, wherein the high temperature is held for 10 seconds.

24. A method of packaging a jelly drink, as claimed in claims 1 to 8.

25. A method as claimed in claim 24, wherein the method comprises packaging a jelly drink into a flexible container made of any suitable water and impermeable material.

26. A method as claimed in any one of claims 24 to 25, wherein the flexible container is made of plastic.

27. A method as claimed in any one of claims 24 to 26, wherein the flexible container is provided with a pre-formed opening covered with a suitable cap.

28. A method as claimed in any one of claims 24 to 27, wherein the flexible container is produced from a material which can be easily torn or cut, providing an opening.

29. A method a claimed in any one of claims 24 to 28, wherein the jelly drink is packaged after the heating cycle when the temperature has cooled slightly.

30. A method as claimed in any one of claims 24 to 29, wherein the jelly drink is packaged at a temperature of 76° C.

31. A method as claimed in any one of claims 24 to 30, wherein the packaged jelly drink is maintained at the packaging temperature for a prolonged period of time to allow sterilisation of the container.

32. A method as claimed in any one of claims 24 to 31, wherein the packaged jelly drink is maintained at the packaged temperature for 2.5 minutes.
